(19) United States
(12) Patent Application Publication
(10) Pub. No.: US 2024/0241420 A1
(43) Pub. Date: Jul. 18, 2024

(54) DISPLAY DEVICE

(71) Applicant: E Ink Holdings Inc., Hsinchu (TW)

(72) Inventors: Ling-Chiang Chu, Hsinchu (TW); Wei-Sung Cheng, Hsinchu (TW); Ming-Huan Yang, Hsinchu (TW); Chen Chu Tsai, Hsinchu (TW); Yen-Ze Huang, Hsinchu (TW); Jen-Shiun Huang, Hsinchu (TW)

(73) Assignee: E Ink Holdings Inc., Hsinchu (TW)

(21) Appl. No.: 18/399,653

(22) Filed: Dec. 28, 2023

(30) Foreign Application Priority Data
Jan. 18, 2023 (TW) 112102275

(51) Int. Cl. G02F 1/167; G02F 1/1681

(52) U.S. Cl. CPC G02F 1/167; G02F 1/1681

(57) ABSTRACT

A display device includes a driving substrate, a display medium layer and a material layer. The display medium layer is disposed on the driving substrate. The material layer is disposed on a side of the display medium layer, and extends to the driving substrate. The material layer is a material layer with conductivity properties.

### CROSS-REFERENCE TO RELATED APPLICATION

This application claims the priority benefit of Taiwan application Ser. No. 11/210,2275, filed on Jan. 18, 2023. The entirety of the above-mentioned patent application is hereby incorporated by reference herein and made a part of this specification.

### BACKGROUND

### Technical Field

The present disclosure relates to a photoelectric device, and more particularly, to a display device.

### Description of Related Art

An existing display device includes an ink layer, a conductive silver pillar, a conductive paste, a conductive film, a water-blocking film and a water-blocking paste. Both the conductive film and the water-blocking film are material layers with bases, so they are not bendable to fit a free-form surface such as the surface of a sphere. In addition, it is required that the distance between the outside of the water-blocking paste and the inside of the conductive silver pillar is set to be at least 5 mm or more, and the distance between the outside of the water-blocking paste and the periphery of the display medium layer should be 1 mm or more. The above-mentioned distances cannot be effectively reduced and will increase the width of the border of the display device, making it impossible to satisfy the need of designing display devices with narrow borders.

### SUMMARY

The present disclosure provides a display device with a border width that may be reduced to meet the design requirement of a narrow border.

The display device of the disclosure includes a driving substrate, a display medium layer and a material layer. The display medium layer is disposed on the driving substrate. The material layer is disposed on a side of the display medium layer, and extends to the driving substrate. The material layer is a material layer with conductivity properties.

In an embodiment of the present disclosure, the material layer is disposed on a side of the display medium layer relatively far away from the driving substrate, and extends to the periphery of the display medium layer.

In an embodiment of the present disclosure, the display device further includes a conductive paste disposed on the display medium layer. The material layer is a conductive material layer which is fixed on the display medium layer through conductive paste, and electrically connected with a conductive terminal on the driving substrate. The thickness of the conductive material layer is greater than 0 and less than or equal to 20 microns.

In an embodiment of the present disclosure, the display device further includes a conductive paste disposed on the display medium layer. The material layer includes a conductive material layer and a water-blocking material layer. The conductive material layer is fixed on the display medium layer through the conductive paste and is electrically connected with the conductive terminal on the driving substrate. The water-blocking material layer is disposed on the conductive material layer and is conformally disposed with the conductive material layer.

In an embodiment of the present disclosure, the thickness of the conductive material layer and the thickness of the water-blocking material layer are respectively greater than 0 and less than or equal to 20 microns.

In an embodiment of the present disclosure, the material layer includes a conductive material layer and a water-blocking material layer. The conductive material layer directly covers the display medium layer and is electrically connected to the conductive terminal on the driving substrate. The water-blocking material layer is disposed on the conductive material layer and completely covers the conductive material layer.

In an embodiment of the present disclosure, the thickness of the water-blocking material layer is greater than 0 and less than or equal to 20 microns.

In an embodiment of the present disclosure, the display medium layer is a microcup electronic ink layer, and the display device further includes a conductive film and a conductive paste. The conductive film is disposed on the display medium layer. The conductive paste is disposed on the display medium layer, and the conductive film is fixed on the display medium layer through the conductive paste. The material layer includes a conductive pillar and a water-blocking material layer. The material layer is disposed between the conductive paste and the driving substrate, and is electrically connected to the conductive paste and a conductive terminal on the driving substrate. The water-blocking material layer is disposed on the conductive film and extends to the driving substrate along the periphery of the conductive film, the periphery of the conductive paste, the periphery of the conductive pillar and the periphery of the display medium layer.

In an embodiment of the present disclosure, the display medium layer is a plastic substrate of an electrophoretic display layer, and the material layer is a conductive material layer.

In an embodiment of the present disclosure, the display device further includes a protection cover, including a cover and a transparent conductive layer. The cover is disposed on the display medium layer, and the transparent conductive layer is disposed on the cover. Part of the transparent conductive layer is located between the cover and the display medium layer.

In an embodiment of the present disclosure, the material layer is disposed between the transparent conductive layer and a non-display area of the display medium layer, and extends to a conductive terminal of the driving substrate along a side of the display medium layer. The transparent conductive layer is electrically connected with the conductive terminal through the material layer.

In an embodiment of the present disclosure, the display device further includes an encapsulant and a protection layer. The encapsulant covers part of a side of the protection cover and part of the material layer. An orthographic projection of the conductive terminal on the driving substrate overlaps an orthographic projection of the encapsulant on the driving substrate. The protection layer covers the encapsulant, the side of the protection cover, part of the material layer and the driving substrate.

In an embodiment of the present disclosure, the display device further includes an encapsulant and a protection layer. The encapsulant covers part of a side of the protection cover and part of the material layer. The protection layer covers the encapsulant, the side of the protection cover, part of the material layer and the driving substrate. An orthographic projection of the conductive terminal on the driving substrate overlaps an orthographic projection of the protection layer on the driving substrate.

In an embodiment of the present disclosure, in a top view, the shape of the conductive terminal includes a circle, an ellipse or a rectangle.

In an embodiment of the present disclosure, a side of the protection cover protrudes by a distance relative to a side of the display medium layer. The material layer is disposed on the transparent conductive layer outside the side of the display medium layer, and extends to a conductive terminal of the driving substrate along the side of the display medium layer. The transparent conductive layer is electrically connected to the conductive terminal of the driving substrate through the material layer.

Based on the above, in the display device of the present disclosure, the material layer having conductive properties extends from one side of the display medium layer to the driving substrate. Thereby, the space occupied by the material layer in the border of the display device may be reduced, so that the display device of the present disclosure has an advantage with a narrow border or an ultra-narrow border, thereby meeting the design requirement of narrow border.

In order to make the above-mentioned features and advantages of the present disclosure more comprehensible, the following embodiments are given and described in detail with the accompanying drawings as follows.

### BRIEF DESCRIPTION OF THE DRAWINGS

FIG. 1 is a schematic cross-sectional view of a display device according to an embodiment of the present disclosure.

FIG. 2 is a schematic cross-sectional view of a display device according to another embodiment of the present disclosure.

FIG. 3 is a schematic cross-sectional view of a display device according to yet another embodiment of the present disclosure.

FIG. 4 is a schematic cross-sectional view of a display device according to still another embodiment of the present disclosure.

FIG. 5 is a schematic cross-sectional view of a display device according to yet another embodiment of the present disclosure.

FIG. 6A is a schematic cross-sectional view of a display device according to still another embodiment of the present disclosure.

FIG. 6B is a partial top perspective view of the display device shown in FIG. 6A.

FIG. 6C and FIG. 6D are top perspective views of the conductive terminal of the driving substrate according to multiple embodiments of the present disclosure.

FIG. 7 is a schematic cross-sectional view of a display device according to another embodiment of the present disclosure.

FIG. 8 is a schematic cross-sectional view of a display device according to yet another embodiment of the present disclosure.

FIG. 9 is a schematic cross-sectional view of a display device according to still another embodiment of the present disclosure.

### DESCRIPTION OF THE EMBODIMENTS

The embodiments of the present disclosure can be understood together with the drawings, and the drawings of the present disclosure are also regarded as a part of the disclosure description.

It is to be understood that the drawings of the present disclosure are not to scale and, in fact, the dimensions of elements may be arbitrarily enlarged or reduced in order to clearly represent the features of the present disclosure.

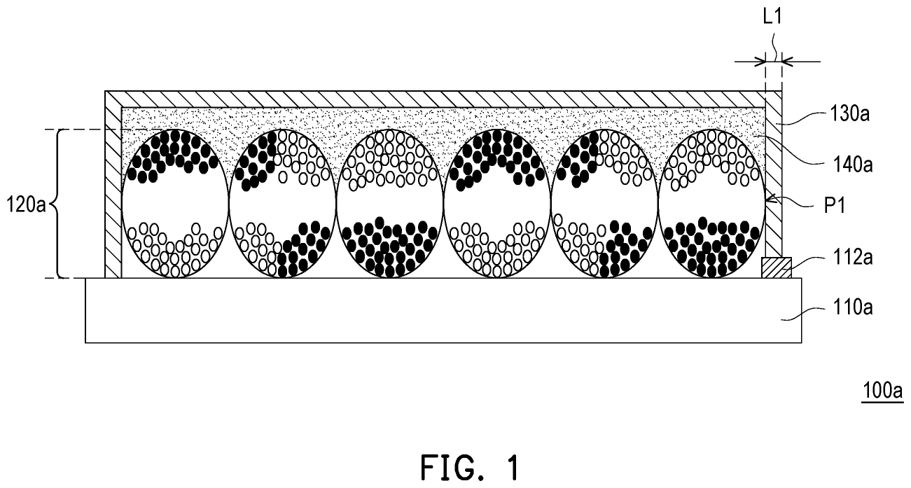

FIG. 1 is a schematic cross-sectional view of a display device according to an embodiment of the present disclosure. Please refer to FIG. 1, in the present embodiment, the display device 100a includes a driving substrate 110a, a display medium layer 120a and a material layer 130a. The display medium layer 120a is disposed on the driving substrate 110a. The material layer 130a is disposed on a side of the display medium layer 120a relatively far away from the driving substrate 110a, and extends to the driving substrate 110a along the periphery P1 of the display medium layer 120a. Specifically, the material layer 130a of this embodiment is a material layer having a conductive property without a base.

In detail, in this embodiment, the display device 100a is embodied as a reflective display device, such as an electrophoretic display device, but not limited thereto. The driving substrate 110a is, for example, an active device array substrate, such as a thin film transistor (TFT) array substrate or a thin film diode (TFD) array substrate, but not limited thereto. The display medium layer 120a is, for example, a microcapsule electronic ink layer.

Please refer to FIG. 1 further, the display device 100a of this embodiment further includes a conductive paste 140a, and the conductive paste 140a is disposed on the display medium layer 120a. The material layer 130a is embodied as a conductive material layer, fixed on the display medium layer 120a through the conductive paste 140a, and electrically connected to a conductive terminal 112a on the driving substrate 110a. That is to say, the material layer 130a of this embodiment has a conductive property, and therefore is able to replace the function served by the conductive films and the conductive silver pillars in the related art. In this embodiment, the material of the material layer 130a may be, for example, poly(3,4-ethylenedioxy thiophene) (PEDOT) or aluminum zinc oxide (AZO), and the material layer 130a may directly contact the conductive terminal 112a on the driving substrate 110a to achieve electrical conduction. Therefore, this embodiment may effectively reduce the width of the border, so that the display device 100a of this embodiment may be designed with narrow border or ultra-narrow border.

It should be noted that in this embodiment, a wet process (such as spraying) is adopted to form a conductive material layer (i.e., material layer 130a) with a thickness L1 greater than 0 and less than or equal to 20 microns to conductively encapsulate the display medium layer 120a to achieve a design with a narrow border or an ultra-narrow border. Through the use of the wet process, the material layer 130a is embodied as a material layer without a base, thereby effectively reducing the border width of the display device 100a. Moreover, because no conductive silver pillars are provided, it is possible to achieve an Ag-free design. In an embodiment, the material layer 130a may directly contact the periphery P1 of the display medium layer 120a, and encapsulate the conductive paste 140a and the display medium layer 120a with the driving substrate 110a.

In short, since the material layer 130a having conductive properties without a base is extended to the driving substrate 110a from one side of the display medium layer 120a relatively far away from the driving substrate 110a along the periphery P1 of the display medium layer 120a, it is possible to reduce the space occupied by the material layer 130a in the border of the display device 100a, so that the display device 100a of this embodiment has an advantage with a narrow border or an ultra-narrow border, thus meeting the design requirements of a narrow border.

It must be noted here that the following embodiments continue to use the component numbers and part of the content of the previous embodiments, wherein the same numbers are used to represent the same or similar components, and the description of the same technical content is omitted. For the description of omitted parts, reference may be made to the foregoing embodiments, and will not be repeated in the following embodiments.

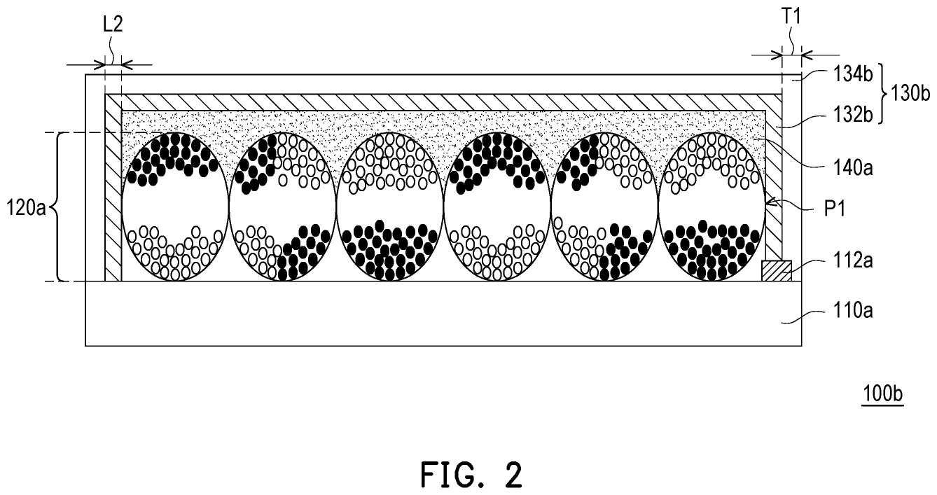

FIG. 2 is a schematic cross-sectional view of a display device according to another embodiment of the present disclosure. Please refer to FIG. 1 and FIG. 2 at the same time. The display device 100b of this embodiment is similar to the display device 100a of FIG. 1. The difference between the two lies in that, in the present embodiment, the material layer 130b includes a conductive material layer 132b and a water-blocking material layer 134b. The conductive material layer 132b is fixed on the display medium layer 120a through the conductive paste 140a and is electrically connected to the conductive terminal 112a on the driving substrate 110a, and the conductive material layer 132b has conductive properties and therefore is able to replace the function served by the conductive films and conductive silver pillars in the related art. The water-blocking material layer 134b is disposed on the conductive material layer 132b and is conformally disposed with the conductive material layer 132b. The water-blocking material layer 134b has waterproof properties and therefore is able to replace the function served by the water-blocking film and water-blocking paste in the related art. That is to say, the material layer 130b of this embodiment may have both conductive and waterproof properties.

In this embodiment, the material layer 130b is formed by using a wet process (such as spraying), and the thickness L2 of the conductive material layer 132b is, for example, greater than 0 and less than or equal to 20 microns, and the thickness T1 of the water-blocking material layer 134b is, for example, greater than 0 and less than or equal to 20 microns. The material of the conductive material layer 132b may be, for example, poly(3,4-ethylenedioxy thiophene) (PEDOT) or aluminum zinc oxide (AZO), and the conductive material layer 132b may directly contact the conductive terminal 112a on the driving substrate 110a to achieve electrical conduction. Therefore, the width of the border may be effectively reduced, so that the display device 100b is able to achieve the design with a narrow border or ultra-narrow border. The material of the water-blocking material layer 134b is, for example, silicon oxide (SiO_{X}) or silicon nitride (SiN_{X}), thereby serving the water-blocking function. In the meantime, because the thickness T1 is less than or equal to 20 microns, the display device 100b may be designed with a narrow border or ultra-narrow border.

In short, in this embodiment, the display medium layer 120a is conductively encapsulated through the conductive material layer 132b of the material layer 130b, and the display medium layer 120a is waterproofly encapsulated through the water-blocking material layer 134b of the material layer 130b. Since the material layer 130b with conductive and waterproof properties with no base is extended to the driving substrate 110a from one side of the display medium layer 120a relatively far away from the driving substrate 110a along the periphery P1 of the display medium layer 120a, it is possible to reduce the space occupied by the material layer 130b in the border of the display device 100b. In this way, the display device 100b of this embodiment may have an advantage with a narrow border or an ultra-narrow border, thereby meeting the design requirement of a narrow border. In addition, through the use of the wet process, the material layer 130b is embodied as a material layer without a base, so it is possible to effectively reduce the border width of the display device 100b, thereby achieving a narrow border or an ultra-narrow border. Moreover, because there is no need to provide conductive silver pillars, no silver is required (Ag free), and a flat display device 100b may be formed.

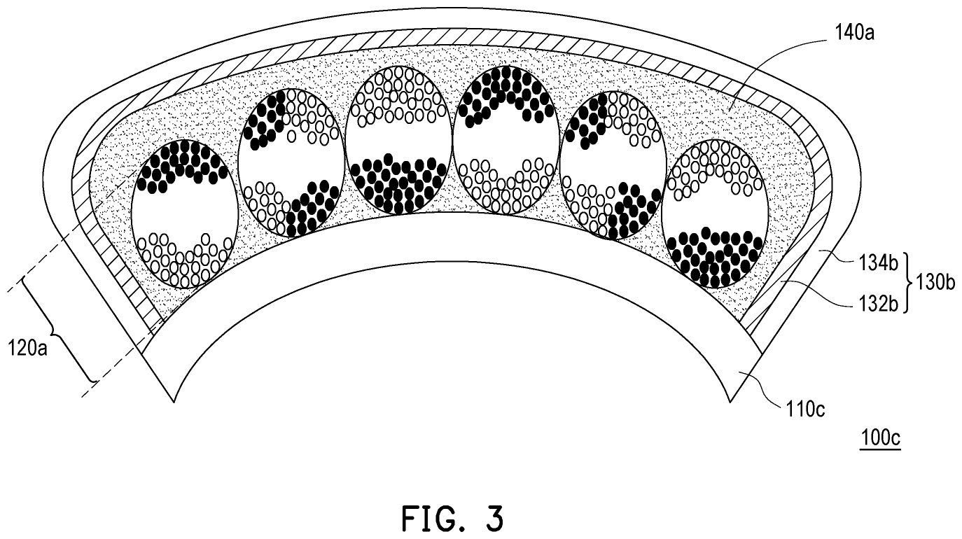

FIG. 3 is a schematic cross-sectional view of a display device according to another embodiment of the present disclosure. Please refer to FIG. 2 and FIG. 3 at the same time. The display device 100c of this embodiment is similar to the display device 100b of FIG. 2. The difference between the two lies in that, in the present embodiment, the driving substrate 110c of this embodiment is embodied as a flexible driving substrate. Since this embodiment adopts a wet process to form the material layer 130b, both the material layer 130b without a base and the flexible driving substrate 110c are bendable/curved to form a non-flat (i.e., free-form surface) display device 100c.

In short, the material layer 130b of this embodiment may be used in flat and non-flat (i.e., free-form surface) encapsulation, thereby effectively reducing the border width of the display devices 100b and 100c, thus achieving a design with a narrow border or an ultra-narrow border.

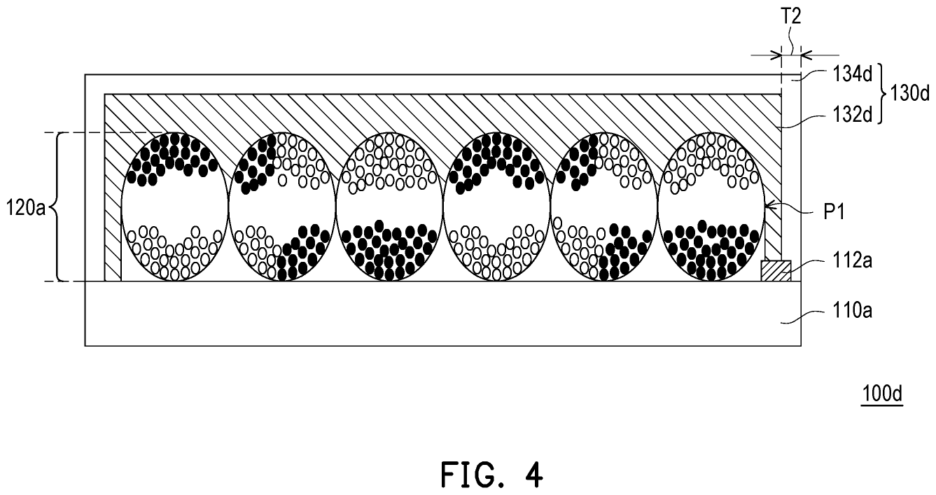

FIG. 4 is a schematic cross-sectional view of a display device according to yet another embodiment of the present disclosure. Please refer to FIG. 1 and FIG. 4 at the same time. The display device 100d of this embodiment is similar to the display device 100a of FIG. 1. The difference between the two lies in that, in this embodiment, the conductive paste 140a in FIG. 1 is not provided. In detail, in this embodiment, the material layer 130d includes a conductive material layer 132d and a water-blocking material layer 134d. The conductive material layer 132d directly covers the display medium layer 120a and is electrically connected to the conductive terminal 112a on the driving substrate 110a. The conductive material layer 132d is able to replace the functions served by the conductive film, conductive paste and conductive silver paste in the related art. The water-blocking material layer 134d is disposed on the conductive material layer 132d and completely covers the conductive material layer 132d, and the water-blocking material layer 134d is able to replace the functions served by the water-blocking film and water-blocking paste in the related art. That is to say, the material layer 130d of this embodiment may have both conductive and waterproof properties.

In this embodiment, the material layer 130d is formed by using a wet process (such as spraying). The thickness T2 of the water-blocking material layer 134d is, for example, greater than 0 and less than or equal to 20 microns. The material of the conductive material layer 132d may be, for example, poly(3,4-ethylenedioxy thiophene) (PEDOT) or aluminum zinc oxide (AZO), and the conductive material layer 132d may directly contact the conductive terminal 112a on the driving substrate 110a to achieve electrical conduction. Therefore, the width of the border may be effectively reduced, so that it is possible for the display device 100d to achieve the design with a narrow border or an ultra-narrow border. The material of the water-blocking material layer 134d is, for example, silicon oxide (SiO_{X}) or silicon nitride (SiN_{X}), thereby serving the water-blocking function. Meanwhile, because the thickness T2 is less than or equal to 20 microns, it is possible for the display device 100d to achieve the design with a narrow border or an ultra-narrow border.

In short, in this embodiment, the display medium layer 120a is conductively encapsulated through the conductive material layer 132d of the material layer 130d, and the display medium layer 120a is waterproofly encapsulated through the water-blocking material layer 134d of the material layer 130d. Since the material layer 130d having conductive and waterproof properties with no base is extended to the driving substrate 110a from one side of the display medium layer 120a relatively far away from the driving substrate 110a along the periphery P1 of the display medium layer 120a, it is possible to reduce the space occupied by the material layer 130d in the border of the display device 100d. In this way, the display device 100d of this embodiment may have an advantage with a narrow border or an ultra-narrow border, thereby meeting the design requirement of a narrow border. In addition, through the use of the wet process, the material layer 130d is embodied as a material layer without a base, so it is possible to effectively reduce the border width of the display device 100d, thereby achieving a narrow border or an ultra-narrow border. Moreover, because there is no need to provide conductive silver pillars and conductive paste, no silver is required (Ag free), and a flat display device 100d may be formed.

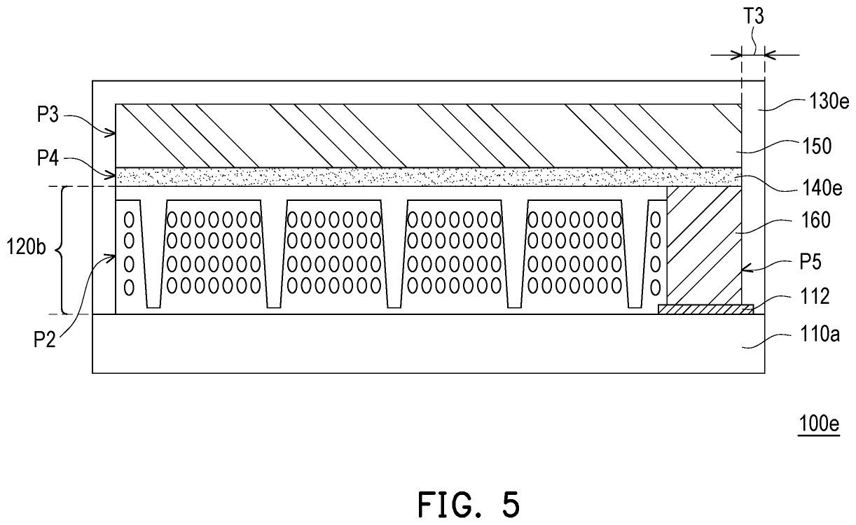

FIG. 5 is a schematic cross-sectional view of a display device according to still another embodiment of the present disclosure. Please refer to FIG. 1 and FIG. 5 at the same time. The display device 100e of this embodiment is similar to the display device 100a of FIG. 1, the difference between the two is that the display medium layer 120b of this embodiment is embodied as a microcup electronic ink layer.

In detail, in this embodiment, the display device 100e further includes a conductive film 150, and the material layer includes a conductive pillar 160 and a water-blocking material layer 130e. The conductive film 150 is disposed on the display medium layer 120b, and the conductive film 150 is fixed on the display medium layer 120b through the conductive paste 140e. The material layer is disposed between the conductive paste 140e and the driving substrate 110a, and is electrically connected to the conductive paste 140e and the conductive terminal 112a on the driving substrate 110a. The water-blocking material layer 130e is disposed on the conductive film 150 and extends to the driving substrate 110a along the periphery P3 of the conductive film 150, the periphery P4 of the conductive paste 140e, the periphery P5 of the conductive pillar 160, and the periphery P2 of the display medium layer 120b. In this embodiment, the water-blocking material layer 130e has waterproof properties, and therefore is able to replace the functions served by the water-blocking film and water-blocking paste in the related art. That is to say, the material layer 130e of this embodiment is waterproof.

In this embodiment, the water-blocking material layer 130e is formed by using a wet process (such as spraying). The thickness T3 of the water-blocking material layer 130e is, for example, greater than 0 and less than or equal to 20 microns. The material of the water-blocking material layer 130e is, for example, silicon oxide (SiO_{X}) or silicon nitride (SiN_{X}), thereby serving the water-blocking function. Meanwhile, because the thickness T3 is less than or equal to 20 microns, it is possible for the display device 100e to achieve the design with a narrow border or an ultra-narrow border.

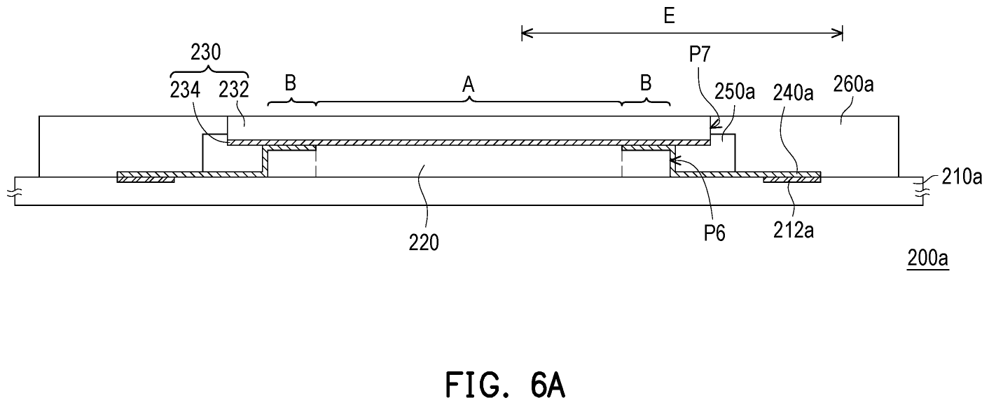

FIG. 6A is a schematic cross-sectional view of a display device according to another embodiment of the present disclosure. FIG. 6B is a partial top perspective view of the display device in FIG. 6A. FIG. 6C and FIG. 6D are top perspective views of the conductive terminal of the driving substrate according to multiple embodiments of the present disclosure. It should be noted that FIG. 6B is a top perspective view of the area E in FIG. 6A.

Please refer to FIG. 1 and FIG. 6A at the same time. The display device 200a of this embodiment is similar to the display device 100a of FIG. 1. The difference between the two lies in that the display medium layer 220 of this embodiment is embodied as a plastic substrate of an electrophoretic display layer, and the material layer 240a is embodied as a conductive material layer. Here, the display medium layer 220 may be a liquid crystal display layer. The material of the material layer 240a may be, for example, poly(3,4-ethylenedioxy thiophene) (PEDOT), which is a fluid and volatile conductive material.

In detail, in this embodiment, the display device 200a further includes a protection cover 230 including a cover 232 and a transparent conductive layer 234. The cover 232 is disposed on the display medium layer 220, and the transparent conductive layer 234 is disposed on the cover 232. Part of the transparent conductive layer 234 is located between the cover 232 and the display medium layer 220. The display medium layer 220 has a display area A and a non-display area B surrounding the display area A. The material layer 240a is disposed between the transparent conductive layer 234 and the non-display area B of the display medium layer 220, and is extended to the conductive terminal 212a of the driving substrate 210a along one side P6 of the display medium layer 220. The transparent conductive layer 234 is electrically connected to the conductive terminal 212a of the driving substrate 210a through the material layer 240a. Here, as shown in FIG. 6B, in a top view, the shape of the conductive terminal 212a is, for example, a circle, but the disclosure is not limited thereto. In other embodiments, please refer to FIG. 6C, in a top view, the shape of the conductive terminal 214 of the driving substrate 210 is, for example, an ellipse; or, please refer to FIG. 6D, in a top view, the shape of the conductive terminal 216 of the driving substrate 210 is, for example, a rectangle, which all belong to the scope to be protected by the present disclosure. As shown in FIG. 6B, in a top view, the coating area of the material layer 240a is extended to overlap with the protection cover 230 from the conductive terminal 212a and is electrically connected to the transparent conductive layer 234 of the protection cover 230. In this embodiment, the width of the material layer 240a in the direction X is as wide as the width of the driving substrate 210, but the present disclosure is not limited thereto. It will suffice as long as the coating area of the material layer 240a covers the conductive terminal 212a and the transparent conductive layer 234 of the protection cover 230, thereby making it possible to electrically connect the conductive terminal 212a and the transparent conductive layer 234.

It should be noted that the conductive terminals 212a, 214, and 216 are, for example, metal pads, which are able to provide the voltage signals output by the driving substrates 210a and 210 to the transparent conductive layer 234 of the protection cover 230. That is to say, the integrated circuits (IC) located on the driving substrates 210a and 210 output voltage signals, and the voltage signals are provided to the transparent conductive layer 234 located on the protection cover 230 through the conductive terminals 212a, 214 and 216 as well as the material layer 240a (i.e., the conductive material layer). In this way, the conductive terminals 212a, 214, and 216 are conductively connected to the transparent conductive layer 234, so as to control the electric field voltage difference when the display device 200a is driven, and further enable the display device 200a to display images.

In addition, please refer to FIG. 6A further. In this embodiment, the display device 200a further includes an encapsulant 250a and a protection layer 260a. The encapsulant 250a covers part of a side P7 of the protection cover 230 and part of the material layer 240a. The protection layer 260a covers the encapsulant 250a, the side P7 of the protection cover 230, part of the material layer 240a and the driving substrate 210a. Here, the orthographic projection of the conductive terminal 212a on the driving substrate 210a overlaps the orthographic projection of the protection layer 260a on the driving substrate 210a.

In the manufacturing process, poly(3,4-ethylenedioxy thiophene) (PEDOT) may be titrated on a position above the display medium layer 220 and on the conductive area (including the conductive terminal 212a) of the driving substrate 210a. After being attached to the displaying medium layer 220 through the protection cover 230 and being volatilized by baking, a material layer 240a is formed in this area, so as to achieve the function of driving the display device 200a. Next, the encapsulant 250a is coated and a dispensing process is performed in the bending area to form the protection layer 260a. Finally, the bending area is bent to complete the fabrication of the display device 200a. In this embodiment, the material layer 240a is adopted to replace the non-bendable silver paste in the related art, so the restriction of the silver paste being not bendable may be overcome. In this way, it is possible for the display device 200a to have the design with a narrow border. In another embodiment of the present disclosure, the protection layer 260a may be manufactured first, followed by coating the encapsulant 250a. In this way, another structure of the present disclosure is that the encapsulant 250a serves to cover above the protection layer 260a.

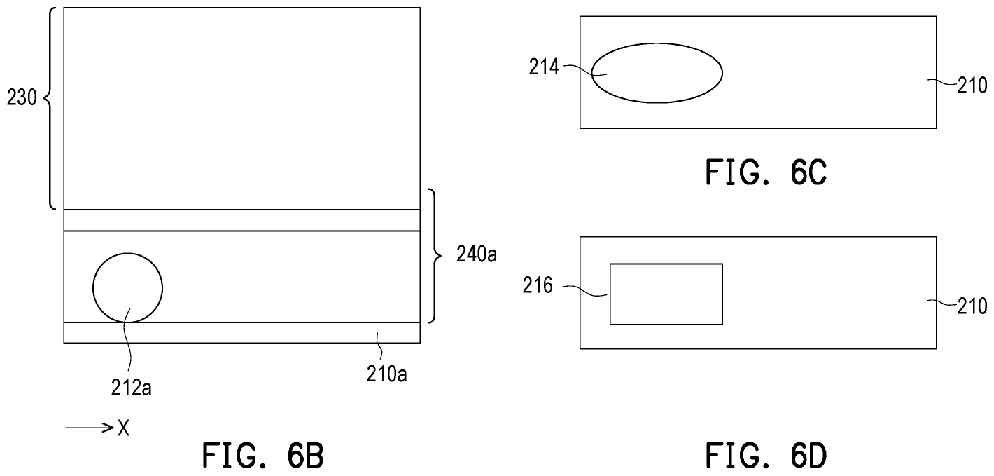

FIG. 7 is a schematic cross-sectional view of a display device according to yet another embodiment of the present disclosure. Please refer to FIG. 6A and FIG. 7 at the same time. The display device 200b of this embodiment is similar to the display device 200a of FIG. 6A. The difference between the two is that, in the present embodiment, the orthographic projection of the conductive terminal 212b on the driving substrate 210b overlaps the orthographic projection of the encapsulant 250b on the driving substrate 210b. The protection layer 260b covers the encapsulant 250b, a side P7 of the protection cover 230, part of the material layer 240b and the driving substrate 210b.

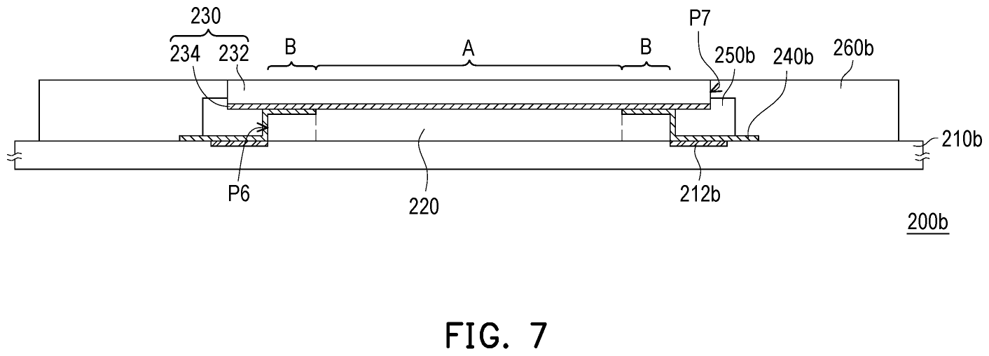

FIG. 8 is a schematic cross-sectional view of a display device according to still another embodiment of the present disclosure. Please refer to FIG. 6A and FIG. 8 at the same time. The display device 200c of this embodiment is similar to the display device 200a of FIG. 6A. The difference between the two is: in this embodiment, a side P7 of the protection cover 230 protrudes by a distance D relative to a side P6 of the display medium layer 220. The material layer 240c is disposed on the transparent conductive layer 234 outside the side P6 of the display medium layer 220, and extends to the conductive terminal 212a of the driving substrate 210a along the side P6 of the display medium layer 220. That is to say, the material layer 240 is not disposed between the transparent conductive layer 234 and the display medium layer 220. The transparent conductive layer 234 is electrically connected to the conductive terminal 212a of the driving substrate 210a through the material layer 240c. Here, the orthographic projection of the conductive terminal 212a on the driving substrate 210a overlaps the orthographic projection of the protection layer 260a on the driving substrate 210a.

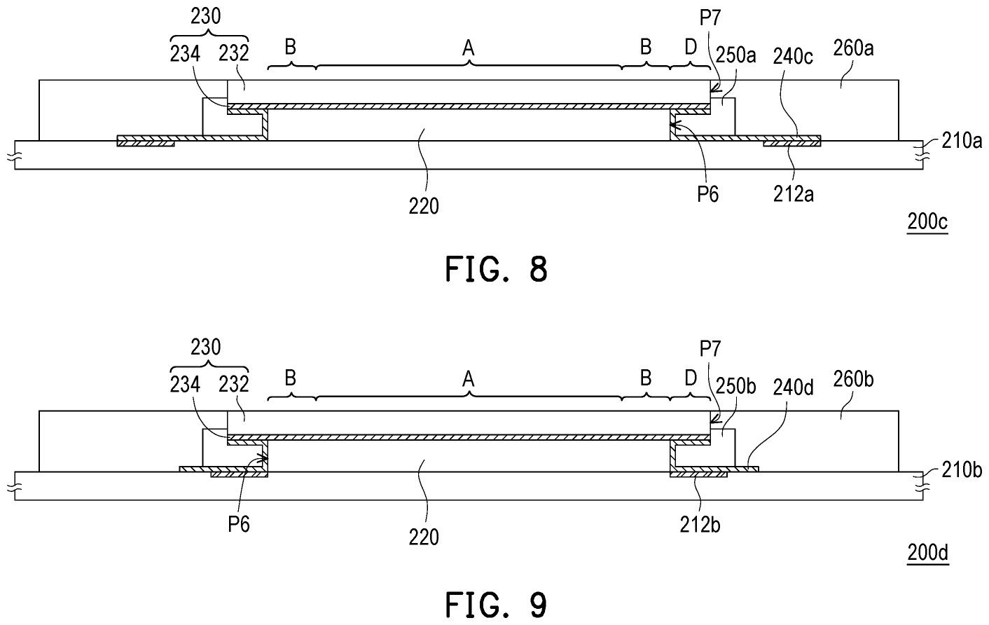

FIG. 9 is a schematic cross-sectional view of a display device according to another embodiment of the present disclosure. Please refer to FIG. 8 and FIG. 9 at the same time. The display device 200d of this embodiment is similar to the display device 200c of FIG. 8. The difference between the two is that, in the present embodiment, the orthographic projection of the conductive terminal 212b on the driving substrate 210b overlaps the orthographic projection of the encapsulant 250b on the driving substrate 210b. The protection layer 260b covers the encapsulant 250b, the side P7 of the protection cover 230, part of the material layer 240b and the driving substrate 210b.

To sum up, in the display device of the present disclosure, the material layer having conductive properties extends from one side of the display medium layer to the driving substrate. Thereby, the space occupied by the material layer in the border of the display device may be reduced, so that the display device of the present disclosure has an advantage with a narrow border or an ultra-narrow border, thereby meeting the design requirement of narrow border.

Although the present disclosure has been disclosed above with embodiments, it is not intended to limit the present disclosure. Anyone with ordinary knowledge in the technical field can make some changes and modifications without departing from the spirit and scope of the present disclosure. Therefore, the scope to be protected by the present disclosure shall be determined by the scope of the appended claims.

What is claimed is:

1. A display device, comprising:
a driving substrate;
a display medium layer, disposed on the driving structure; and
a material layer, disposed on a side of the display medium layer, and extending to the driving substrate, wherein the material layer is a material layer with conductivity properties.

2. The display device according to claim 1, wherein the material layer is disposed on a side of the display medium layer relatively far away from the driving substrate, and extends to a periphery of the display medium layer.

3. The display device according to claim 2, further comprising:
a conductive paste, disposed on the display medium layer, wherein the material layer is a conductive material layer which is fixed on the display medium layer through conductive paste, and electrically connected with a conductive terminal on the driving substrate, and a thickness of the conductive material layer is greater than 0 and less than or equal to 20 microns.

4. The display device according claim 2, further comprising:
a conductive paste, disposed on the display medium layer, wherein the material layer comprises a conductive material layer and a water-blocking material layer, the conductive material layer is fixed on the display medium layer through the conductive paste and is electrically connected with a conductive terminal on the driving substrate, and the water-blocking material layer is disposed on the conductive material layer and is conformally disposed with the conductive material layer.

5. The display device according to claim 4, wherein a thickness of the conductive material layer and a thickness of the water-blocking material layer are respectively greater than 0 and less than or equal to 20 microns.

6. The display device according to claim 2, wherein the material layer comprises a conductive material layer and a water-blocking material layer, the conductive material layer directly covers the display medium layer and is electrically connected to a conductive terminal on the driving substrate, and the water-blocking material layer is disposed on the conductive material layer and completely covers the conductive material layer.

7. The display device according to claim 6, wherein a thickness of the water-blocking material layer is greater than 0 and less than or equal to 20 microns.

8. The display device according to claim 1, wherein the display medium layer is a microcup electronic ink layer, and the display device further comprises:
a conductive film, disposed on the display medium layer; and
a conductive paste, disposed on the display medium layer, wherein the conductive film is fixed on the display medium layer through the conductive paste;
wherein the material layer comprises a conductive pillar and a water-blocking material layer, the material layer is disposed between the conductive paste and the driving substrate, and is electrically connected to the conductive paste and a conductive terminal on the driving substrate, the water-blocking material layer is disposed on the conductive film and extends to the driving substrate along a periphery of the conductive film, a periphery of the conductive paste, a periphery of the conductive pillar and a periphery of the display medium layer.

9. The display device according to claim 1, wherein the display medium layer is a plastic substrate of an electrophoretic display layer, and the material layer is a conductive material layer.

10. The display device according to claim 9, further comprising:
a protection cover, comprising a cover and a transparent conductive layer, wherein the cover is disposed on the display medium layer, and the transparent conductive layer is disposed on the cover, and a part of the transparent conductive layer is located between the cover and the display medium layer.

11. The display device according to claim 10, wherein the material layer is disposed between the transparent conductive layer and a non-display area of the display medium layer, and extends to a conductive terminal of the driving substrate along the side of the display medium layer, the transparent conductive layer is electrically connected with the conductive terminal through the material layer.

12. The display device according to claim 11, wherein in a top view, a shape of the conductive terminal comprises a circle, an ellipse or a rectangle.

13. The display device according to claim 10, further comprising:
an encapsulant, covering a part of a side of the protection cover and a part of the material layer, wherein an orthographic projection of a conductive terminal on the driving substrate overlaps an orthographic projection of the encapsulant on the driving substrate; and
a protection layer, covering the encapsulant, the side of the protection cover, the part of the material layer and the driving substrate.

14. The display device according to claim 10, further comprising:
an encapsulant, covering a part of a side of the protection cover and a part of the material layer; and
a protection layer, covering the encapsulant, the side of the protection cover, the part of the material layer and the driving substrate, wherein an orthographic projection of a conductive terminal on the driving substrate overlaps an orthographic projection of the protection layer on the driving substrate.

15. The display device according to claim 10, wherein a side of the protection cover protrudes by a distance relative to the side of the display medium layer, the material layer is disposed on the transparent conductive layer outside the side of the display medium layer, and extends to a conductive terminal of the driving substrate along the side of the display medium layer, the transparent conductive layer is electrically connected to the conductive terminal of the driving substrate through the material layer.
